(19) United States
(12) Patent Application Publication
(10) Pub. No.: US 2025/0370413 A1
(43) Pub. Date: Dec. 4, 2025

(54) Real-Time Clock Device

(71) Applicant: SEIKO EPSON CORPORATION, Tokyo (JP)

(72) Inventor: Jun SHIINA, Minowa (JP)

(21) Appl. No.: 19/220,686

(22) Filed: May 28, 2025

(30) Foreign Application Priority Data
May 29, 2024 (JP) 2024-086858

(51) Int. Cl. G04G 7/00; G04G 3/02; G06F 1/08; G06F 1/14

(52) U.S. Cl. CPC G04G 7/00; G04G 3/02; G06F 1/08; G06F 1/14

(57) ABSTRACT

A real-time clock device includes an input terminal to which a reference pulse signal of a time is input, an oscillation circuit that outputs an oscillation clock signal, a clock count circuit that generates information on an internal time based on the oscillation clock signal, and a processing circuit that performs, in a case in which it is determined that a time lag occurs at the internal time when the reference pulse signal is input, frequency correction of the oscillation clock signal based on a time lag amount and a time interval of the time lag, and time correction of the internal time.

The present application is based on, and claims priority from JP Application Serial Number 2024-086858, filed May 29, 2024, the disclosure of which is hereby incorporated by reference herein in its entirety.

### BACKGROUND

### 1. Technical Field

The present disclosure relates to a real-time clock device or the like.

### 2. Related Art

A real-time clock device that generates time information by performing clocking based on an oscillation clock signal is known. For example, JP-A-2021-189037 discloses a method of correcting a sub-second by reading data of a lower counter of a sub-second at the timing according to a reference pulse signal to measure an error of clock data, and performing a distributed theoretical regulation on an upper counter of the sub-second.

According to the related art of JP-A-2021-189037, the time with higher resolution by using the theoretical regulation can be periodically corrected. However, as time elapses, the frequency accuracy of the clock signal that is the basis of the clock data is lowered due to the aging, and thus there is a problem that it is difficult to provide a highly accurate time without frequently updating the time information.

### SUMMARY

According to an aspect of the present disclosure, there is provided a real-time clock device including an input terminal to which a reference pulse signal of a time is input, an oscillation circuit that outputs an oscillation clock signal, a clock count circuit that generates information on an internal time based on the oscillation clock signal, and a processing circuit that performs, in a case in which it is determined that a time lag occurs at the internal time when the reference pulse signal is input, frequency correction of the oscillation clock signal based on a time lag amount and a time interval of the time lag, and time correction of the internal time.

### BRIEF DESCRIPTION OF THE DRAWINGS

FIG. 1 is a configuration example of a real-time clock device according to the present embodiment.

FIG. 2 is an explanatory diagram of a problem of a method according to a comparative example.

FIG. 3 is an explanatory diagram of a method according to the present embodiment.

FIG. 4 is an explanatory diagram of an input and output signal according to the present embodiment.

FIG. 5 is a detailed configuration example of the real-time clock device according to the present embodiment.

FIG. 6 is a signal waveform diagram illustrating an operation according to the present embodiment.

FIG. 7 is a flowchart illustrating the operation according to the present embodiment.

FIG. 8 is a flowchart illustrating the operation according to the present embodiment.

FIG. 9 is an explanatory diagram of a time correction control according to the present embodiment.

FIG. 10 is an explanatory diagram of the time correction control according to the present embodiment.

FIG. 11 is a detailed configuration example of the real-time clock device according to the present embodiment.

FIG. 12 is a signal waveform diagram illustrating the operation according to the present embodiment.

FIG. 13 is a flowchart illustrating the operation according to the present embodiment.

FIG. 14 is a flowchart illustrating the operation according to the present embodiment.

### DESCRIPTION OF EMBODIMENTS

Hereinafter, the present embodiment will be described. The present embodiment described below does not unreasonably limit the contents described in the aspects. In addition, not all configurations described in the present embodiment are essential configuration requirements.

### 1. Real-Time Clock Device

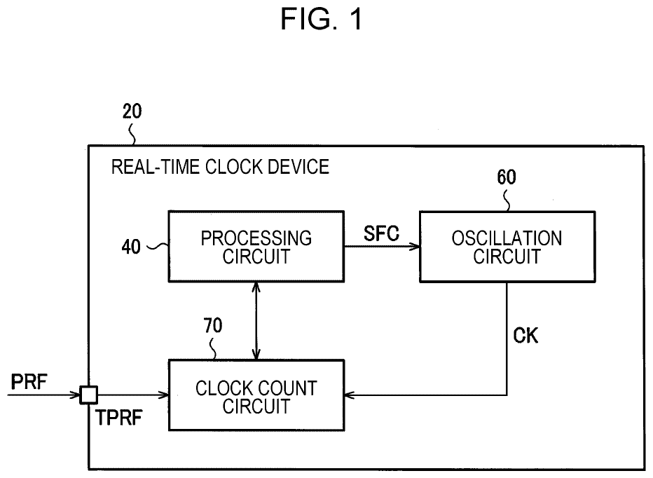

FIG. 1 illustrates a configuration example of a real-time clock device 20 according to the present embodiment. The real-time clock device 20 is a device that generates time information by performing clocking based on, for example, an oscillation clock signal CK, and is, for example, a real-time clock module. The real-time clock device 20 of FIG. 1 includes a processing circuit 40, an oscillation circuit 60, a clock count circuit 70, and an input terminal TPRF of a reference pulse signal PRF. The configuration of the real-time clock device 20 is not limited to the configuration of FIG. 1, and various modifications such as omitting some of the components, adding other components, and replacing some of the components with other components can be implemented.

The input terminal TPRF is a terminal to which the reference pulse signal PRF of the time is input. For example, the input terminal TPRF is an input terminal for external coupling provided in a package of the real-time clock device 20. The reference pulse signal PRF is a reference signal of the time. For example, the edge timing of the reference pulse signal PRF is a reference timing of the time, and is, for example, the timing indicating the hour. As an example of the reference pulse signal PRF, a 1 pulse per second (PPS) signal, which is a timing standard signal in GPS (GNSS) or the like, can be used. In the present embodiment, for example, a reference signal such as 1 PPS output by an external GPS module can be used as the reference pulse signal PRF, but the present disclosure is not limited thereto. For example, the signal may be a signal every 10 seconds, which is longer than one second, instead of a signal every second such as 1 PPS. In addition, when time information is transmitted for time synchronization of a plurality of communication devices communicatively connected via a network, a synchronization signal or the like of the time information may be used as the reference pulse signal PRF. For example, a signal obtained by time synchronization using NTP (Network Time Protocol) or PTP (Precision Time Protocol) may be used as the reference pulse signal PRF.

The oscillation circuit 60 is a circuit that outputs the oscillation clock signal CK. For example, the oscillation circuit 60 generates an oscillation signal by an oscillation operation, and outputs an oscillation clock signal CK based on the oscillation signal. For example, the oscillation circuit 60 generates an oscillation signal having a frequency controlled by the frequency control signal SFC from the processing circuit 40, and outputs an oscillation clock signal CK based on the oscillation signal. As an example, the oscillation circuit 60 generates a sine wave oscillation signal by driving a resonator such as a quartz crystal resonator to oscillate by a drive circuit, and outputs a rectangular wave oscillation clock signal CK by shaping the waveform of the oscillation signal generated by the waveform shaping circuit. For example, the oscillation clock signal CK is a clock signal having a frequency of 32.768 KHz. The frequency of the oscillation clock signal CK is not limited thereto, and may be a frequency such as 32 KHz. In addition, the real-time clock device 20 may have a clock output terminal that outputs the oscillation clock signal CK. The oscillation operation of the oscillation circuit 60 is not limited to the use of such a resonator, and various modifications can be made.

The processing circuit 40 is a circuit that performs various arithmetic processing, control processing, and the like in the real-time clock device 20. The processing circuit 40 can be realized by, for example, a logic circuit, and more specifically, by a circuit of an application specific integrated circuit (ASIC) by automatic arrangement wiring such as a gate array.

The clock count circuit 70 generates information on the internal time based on the oscillation clock signal CK from the oscillation circuit 60. For example, the clock count circuit 70 performs clock counting processing based on the frequency division clock signal obtained by dividing the oscillation clock signal CK by, for example, a frequency division circuit, and generates, for example, time information indicating the current time by the clock counting processing. For example, a frequency division clock signal having a frequency, for example, 1 Hz or 1 KHz is generated by dividing the oscillation clock signal CK by the frequency division circuit, and time information is generated by clock processing based on the frequency division clock signal. The time data, which is the clock information, can include data indicating a second, a minute, an hour, a day, a month, a year, and the like. For example, the clock count circuit 70 has each of the counters for counting each of a second, a minute, an hour, a day, a month, and a year, and generates time information by the counting processing of these counters. For example, the generated time information is output to the outside through an interface circuit or the like. In addition, information on the internal time corresponding to the time information is output from the clock count circuit 70 to the processing circuit 40.

In the present embodiment, the processing circuit 40 performs the frequency correction of the oscillation clock signal CK based on the time lag amount and the time interval of the time lag, and the time correction of the internal time, when it is determined that the time lag occurs at the internal time in a case in which the reference pulse signal PRF is input. For example, the processing circuit 40 monitors the internal time of the real-time clock device 20 at each timing when the reference pulse signal PRF is input, and determines whether or not the time lag occurs at the internal time. For example, the processing circuit 40 determines whether or not the time lag occurs at the internal time based on the information on the internal time generated by the clock processing of the clock count circuit 70. For example, when the internal time obtained by the clock processing of the clock count circuit 70 is strictly accurate, the internal time at each input timing of the reference pulse signal PRF matches the hour, and the time lag does not occur. However, when a situation such as the frequency of the oscillation clock signal CK changes due to the aging occurs, a time lag in which the internal time deviates from the hour occurs. When it is determined that such a time lag of the internal time occurs, the processing circuit 40 performs frequency correction of the oscillation clock signal CK based on the time lag amount and the time interval of the time lag. The time lag amount represents the time lag amount of the internal time, and is, for example, a time error of the internal time. In addition, the time interval of the time lag is a time interval indicating a length of a period in which the time lag having the time lag amount occurs. In addition, the processing circuit 40 performs time correction of the internal time when it is determined that the time lag of the internal time occurs. For example, the processing circuit 40 outputs a signal for instructing the execution of the time correction of the internal time to the clock count circuit 70, and the clock count circuit 70 that receives the signal performs processing of correcting (updating) the internal time to the accurate time. Here, the frequency correction of the oscillation clock signal CK and the time correction of the internal time do not need to be performed at the same timing, and for example, the time correction of the internal time may be performed at the timing when the reference pulse signal PRF is next input after the frequency correction is performed.

As described above, the real-time clock device 20 of the present embodiment includes the input terminal TPRF to which the reference pulse signal PRF of the time is input, the oscillation circuit 60 that outputs the oscillation clock signal CK, the clock count circuit 70 that generates the information on the internal time based on the oscillation clock signal CK, and the processing circuit 40. When it is determined that the time lag occurs at the internal time in a case in which the reference pulse signal PRF is input, the processing circuit 40 performs the frequency correction of the oscillation clock signal CK based on the time lag amount and the time interval of the time lag, and the time correction of the internal time. In this manner, when the time lag occurs in the internal time of the real-time clock device 20, the time correction of the internal time is performed, and the frequency correction of the oscillation clock signal CK used for the clock processing of the internal time is performed. As a result, for example, even when the oscillation frequency of the oscillation circuit 60 is shifted due to the aging or the like, the real-time clock device 20 that can prevent the error in the clock count caused by the shift in the oscillation frequency and provide highly accurate time information can be realized.

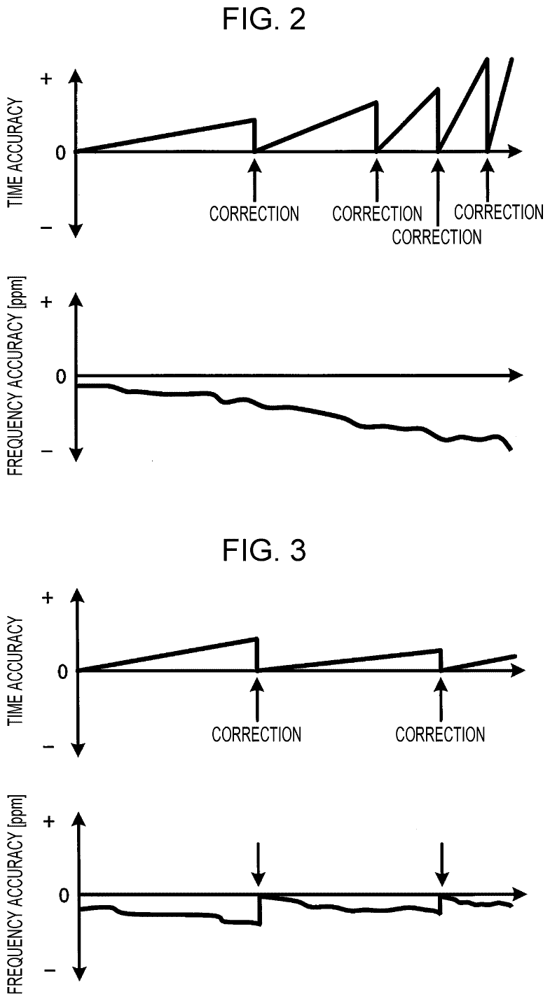

For example, FIG. 2 is an explanatory diagram of a problem of a method according to a comparative example of the present embodiment. In FIG. 2, the frequency error corresponding to the frequency accuracy of the oscillation increases over time due to the aging or the like, and the lag occurs in the internal time due to the frequency error. The correction for eliminating the lag of the internal time caused by such a frequency error is performed. In this case, since the frequency error increases over time, the lag of the internal time also increases, and the frequent correction of the internal time is required.

For example, in a module of a real-time clock (RTC) of one package in the related art, the frequency offset increases over time due to the aging of the resonator which is an internal resonance element, and the time lag is accelerated accordingly. In a state where the time lag is large, in order to maintain highly accurate time information, since it is necessary to frequently perform corrections for updating the time information as illustrated in FIG. 2, it is difficult to provide a highly accurate time.

On the other hand, in order to realize a highly accurate time, a method of performing a theoretical regulation correction of the clock count may be considered. However, since the frequency adjustment is not performed in the theoretical regulation, the clock accuracy remains poor when the clock signal is output from the real-time clock module.

In addition, a method of a time synchronization type in which a time synchronization device supplies a clock pulse of less than a second to a plurality of information processing devices, the information processing device counts the number of the clock pulse to count the time, and the time is cleared to zero when the synchronization signal is input may be considered. However, in this method, since both the synchronization signal and the clock pulse of less than a second are required to be supplied, the wiring increases, and since the clock pulse of less than a second is required to be transmitted, the current consumption increases.

In addition, an oscillator that has a function of detecting an error with the expected frequency based on the reference pulse signal of the GPS module which is a GPS receiver, and executing the frequency correction based on the detection result is also considered, but the oscillator does not perform the time correction using the reference pulse signal.

In addition, in order to realize an accurate clocking clock, a method of performing frequency adjustment of the clock generation circuit by a processing device such as an MCU without using a real-time clock module of one package may be considered. However, in this method, the size and the power consumption of the device become larger than those of the real-time module of one package. In addition, since the frequency adjustment is performed only by the time comparison, there is a problem that the frequency adjustment can be performed only up to the time resolution of the time stamp.

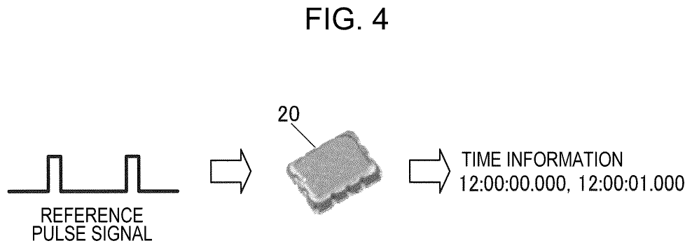

In this regard, in the present embodiment, the input terminal TPRF of the reference pulse signal PRF for correcting both the time and the frequency is provided. It is determined whether or not the time lag occurs in the internal time at the input timing of the reference pulse signal PRF input to the input terminal TPRF, and when it is determined that the time lag occurs, the frequency correction of the oscillation clock signal CK and the time correction of the internal time are executed. For example, the internal time of the real-time clock device 20 is corrected based on the reference pulse signal PRF, and the frequency is corrected based on the lag between the time indicated by the reference pulse signal PRF and the internal time of the real-time clock device 20. Therefore, both the time and the frequency are corrected using only the reference pulse signal PRF. As a result, as illustrated in FIG. 3, the time correction for updating the internal time to the accurate time is performed, and the frequency correction for bringing the frequency error close to zero is performed. Therefore, the real-time clock device 20 that can provide accurate time information and maintain time accuracy can be provided. In addition, as illustrated in FIG. 4 in the present embodiment, the frequency correction of the oscillation clock signal CK and the time correction of the internal time are performed by inputting the reference pulse signal PRF to the real-time clock device 20. Therefore, the real-time clock device 20, which is a real-time clock module of one package, is incorporated with the correction function of the internal time and the correction function of adjusting the oscillation frequency, and highly accurate time information can be provided with a small size and low power consumption.

### 2. Detailed Configuration Example

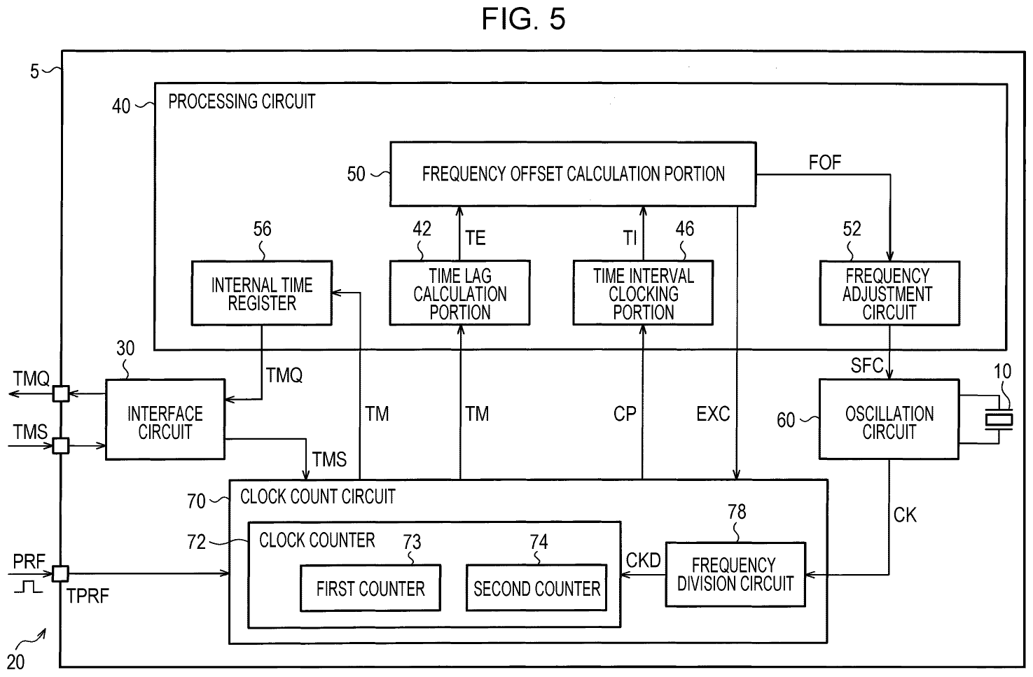

FIG. 5 illustrates a detailed configuration example of the real-time clock device 20 according to the present embodiment. In addition to the processing circuit 40, the oscillation circuit 60, and the clock count circuit 70, the real-time clock device 20 of FIG. 5 is provided with an interface circuit 30. In addition, FIG. 5 illustrates a detailed configuration example of the processing circuit 40 and the clock count circuit 70. The configurations of the real-time clock device 20, the processing circuit 40, and the clock count circuit 70 are not limited to the configurations of FIG. 5, and various modifications such as omitting some of the components, adding other components, and replacing some of the components with other components can be implemented.

In FIG. 5, the oscillation circuit 60 generates an oscillation signal by oscillating a resonator 10, and outputs the oscillation clock signal CK. The resonator 10 is an element that generates mechanical resonation by an electrical signal. The resonator 10 can be realized by a resonator element such as a quartz crystal resonator element. For example, the resonator 10 can be realized by a quartz crystal resonator element having a cut angle that thickness-shear resonates, such as an AT cut or an SC cut, a tuning fork type quartz crystal resonator element, a double tuning fork type quartz crystal resonator element, or the like. The resonator 10 of the present embodiment can also be realized by various resonator elements such as a resonator element other than a thickness-shear resonation type, a tuning fork type, a double tuning fork type, or a piezoelectric resonator element formed of a material other than quartz crystal. For example, as the resonator 10, a surface acoustic wave (SAW) resonator, a micro electro mechanical systems (MEMS) resonator as a silicon resonator formed by using a silicon substrate, or the like can be adopted.

For example, in the real-time clock device 20 of FIG. 5, an integrated circuit device including the interface circuit 30, the processing circuit 40, the oscillation circuit 60, the clock count circuit 70, and the like, and the resonator 10 are accommodated in the package 5. The integrated circuit device is a circuit device called an integrated circuit (IC). For example, the integrated circuit device is an IC manufactured by a semiconductor process, and is a semiconductor chip in which a circuit element is formed above a semiconductor substrate. The resonator 10 is electrically coupled to the integrated circuit device. For example, the resonator 10 and the integrated circuit device are electrically coupled to each other by using internal wiring of the package 5 that accommodates the resonator 10 and the integrated circuit device, a bonding wire, a metal bump, or the like. A modification in which the resonator 10 is not incorporated in the real-time clock device 20 and a resonator 10 provided outside is used can be performed.

The interface circuit 30 is a circuit for performing communication with an external processing device. For example, the interface circuit 30 performs communication based on a given communication standard with an external processing device. For example, the interface circuit 30 performs serial communication such as an inter-integrated circuit (I2C) or a serial peripheral interface (SPI). In the case of serial communication, the real-time clock device 20 includes a communication terminal such as a serial clock input terminal or a serial data input/output terminal. In FIG. 5, the time stamp information TMS, which is the time information, is input to the interface circuit 30. For example, the time stamp information TMS is input to the interface circuit 30 as serial data. In addition, the interface circuit 30 outputs the time information TMQ indicating the current time clocked by the real-time clock device 20.

For example, the oscillation circuit 60 can be realized by a drive circuit for oscillation electrically coupled to one end and the other end of the resonator 10, and a passive element such as a capacitor and a resistor. For example, the drive circuit can be realized by a bipolar transistor or a CMOS inverter circuit. The drive circuit is a core circuit of the oscillation circuit 60, and the drive circuit causes the resonator 10 to oscillate by voltage-driving or current-driving the resonator 10. As the oscillation circuit 60, various types of oscillation circuits such as an inverter type, a Pierce type, a Colpitts type, and a Hartley type can be used.

In addition, the oscillation circuit 60 may include a variable capacitance circuit (not illustrated). For example, the variable capacitance circuit includes a capacitor array having a plurality of capacitors and a switch array having a plurality of switches. Each capacitor of the plurality of capacitors and each switch of the plurality of switches are coupled in series between one end or the other end of the resonator 10 and, for example, a ground node. In addition, the plurality of capacitors of the capacitor array are weighted in binary in the capacitance value. The plurality of switches of the switch array are turned on and off based on the frequency control data which is the frequency control signal SFC from the processing circuit 40. As a result, the capacitance value of the variable capacitance circuit is controlled, and the oscillation frequency of the oscillation circuit 60 is adjusted. Alternatively, the variable capacitance circuit may be realized by, for example, a variable capacitance element such as a varactor. In this case, the frequency control voltage is input to the oscillation circuit 60 as the frequency control signal SFC from the processing circuit 40, and the capacitance of the variable capacitance element is adjusted by the frequency control voltage. Therefore, the oscillation frequency of the oscillation circuit 60 is adjusted. In addition, in the present embodiment, a temperature compensation circuit that performs temperature compensation processing based on the temperature detection signal from the temperature sensor may be provided. In this case, the capacitance of the variable capacitance circuit is adjusted based on the temperature compensation result in the temperature compensation circuit, and thus temperature compensation of the oscillation frequency is performed. The coupling in the present embodiment is an electrical coupling. The electrical coupling is a coupling in which an electrical signal is transmissible, and is a coupling in which information is transmissible by an electrical signal. The electrical coupling may be a coupling via a passive element or the like.

In FIG. 5, the clock count circuit 70 includes a clock counter 72 and a frequency division circuit 78. The frequency division circuit 78 divides the oscillation clock signal CK from the oscillation circuit 60 to generate a frequency division clock signal CKD. For example, the frequency division circuit 78 includes a frequency division counter that operates based on the oscillation clock signal CK, and the frequency division counter generates a frequency division clock signal CKD. For example, the frequency division clock signal CKD is a clock signal having a frequency of 1 Hz. The frequency division circuit 78 may include a first frequency division circuit that divides the oscillation clock signal CK at a first frequency division ratio, and a second frequency division circuit that divides the first frequency division clock signal from the first frequency division circuit at a second frequency division ratio to output a frequency division clock signal CKD which is the second frequency division clock signal. The first frequency division ratio is, for example, 32, and the frequency of the first frequency division clock signal is, for example, 1.024 KHz. The second frequency division ratio is, for example, 1024, and thus the frequency division clock signal CKD of 1 Hz is output from the frequency division circuit 78. The frequency of the frequency division clock signal CKD may be, for example, 1 KHz. In addition, any one of the oscillation clock signal CK, and the frequency division clock signal CKD, which is the first frequency division clock signal or the second frequency division clock signal, may be selected and output from the clock output terminal of the real-time clock device 20.

The clock counter 72 performs the clock counting processing based on the frequency division clock signal CKD from the frequency division circuit 78, and generates the information on the internal time TM. For example, the clock counter 72 has counters for a second, a minute, an hour, a day, a month, and a year, and generates the information on the internal time TM by the counting processing of these counters. The information on the internal time TM is stored in the internal time register 56 of the processing circuit 40 and is output to the outside via the interface circuit 30 as the time information TMQ indicating the current time. For example, the clock counter 72 includes a first counter 73 and a second counter 74. The first counter 73 is a counter that counts an hour, a minute, and a second, and the second counter 74 is a counter that counts less than a second. Details of the first counter 73 and the second counter 74 will be described later.

In addition, in FIG. 5, the processing circuit 40 includes a time lag calculation portion 42, a time interval clocking portion 46, a frequency offset calculation portion 50, a frequency adjustment circuit 52, and an internal time register 56.

The time lag calculation portion 42 calculates the time lag of the internal time TM based on the internal time TM at the timing when the reference pulse signal PRF is input. For example, the timing when the reference pulse signal PRF is input is an edge timing of the reference pulse signal PRF. For example, the time lag calculation portion 42 determines whether or not the time lag occurs by performing the comparison processing based on the value of the internal time TM of the reference pulse signal PRF at the first input timing and the value of the internal time TM of the reference pulse signal PRF at the second input timing after the first input timing. The time lag calculation portion 42 outputs the time lag amount TE to the frequency offset calculation portion 50 when it is determined that the time lag occurs.

The time interval clocking portion 46 clocks the time interval TI in which the time lag occurs, and outputs the clocked time interval TI to the frequency offset calculation portion 50. For example, the time interval clocking portion 46 clocks the time interval from when the time correction is performed to the timing when it is determined that the time lag occurs next as the time interval TI of the time lag. For example, the time interval clocking portion 46 clocks the time interval from the timing when it is determined that there is no time lag of the internal time TM to the timing when it is determined that the time lag of the internal time TM occurs as the time interval TI of the time lag. For example, at the i-th input timing of the reference pulse signal PRF, it is determined that there is no time lag of the internal time TM, and it is determined that the time lag occurs at the j-th input timing of the reference pulse signal PRF (i and j are integers such that j>i). In this case, the period from the i-th input timing to the j-th input timing is clocked as the time interval TI. For example, the clock count circuit 70 outputs the count pulse CP activated every input timing of the reference pulse signal PRF. The time interval clocking portion 46 clocks the time interval TI by counting the number of the count pulses CP. For example, when it is determined that there is no time lag at the i-th input timing and the time lag occurs at the j-th input timing, the time interval clocking portion 46 counts the number of the count pulses CP from the i-th input timing to the j-th input timing to clock the time interval TI of the time lag.

The frequency offset calculation portion 50 performs a calculation for estimating the frequency offset FOF based on the time lag amount TE from the time lag calculation portion 42 and the time interval TI of the time lag from the time interval clocking portion 46. For example, the frequency offset calculation portion 50 obtains the frequency offset as FOF=TE/TI. The frequency adjustment circuit 52 adjusts the frequency of the oscillation circuit 60 based on the frequency offset FOF. For example, the frequency adjustment circuit 52 performs frequency correction so as to cancel the estimated frequency offset FOF. For example, the frequency adjustment circuit 52 generates a frequency control signal SFC for increasing or decreasing the frequency of the oscillation clock signal CK by the amount of the obtained frequency offset FOF, and outputs the frequency control signal SFC to the oscillation circuit 60. The oscillation circuit 60 outputs the oscillation clock signal CK having an oscillation frequency corresponding to the frequency offset FOF. For example, the capacitance of the variable capacitance circuit of the oscillation circuit 60 is controlled by the frequency control signal SFC based on the frequency offset FOF, and thus the oscillation clock signal CK having the oscillation frequency corresponding to the frequency offset FOF is generated.

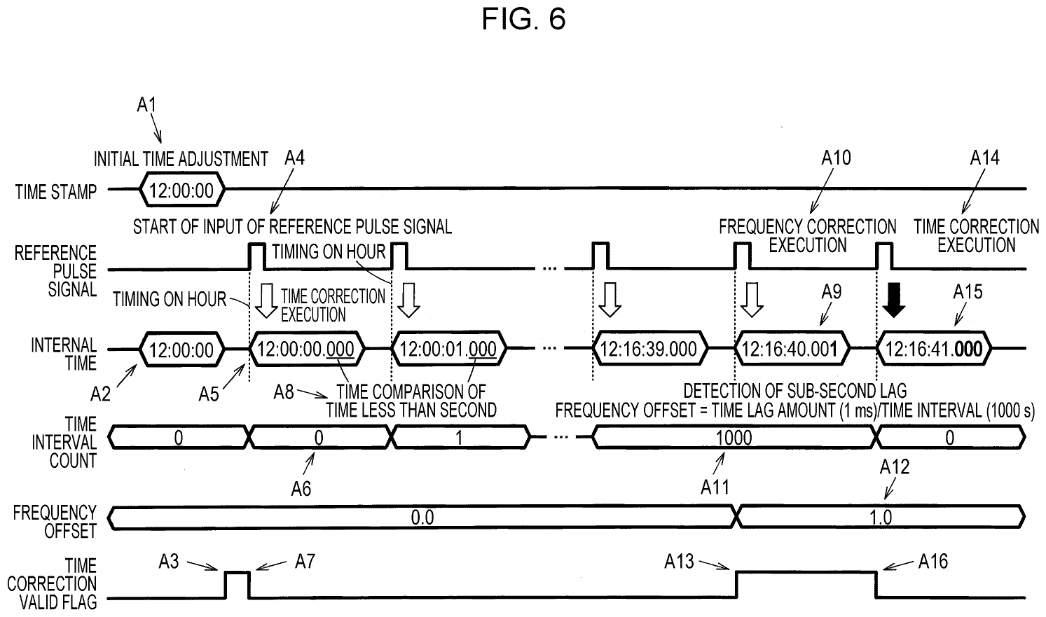

FIG. 6 is a signal waveform diagram illustrating the operation of the real-time clock device 20 of FIG. 5. In the initial time adjustment illustrated in A1 of FIG. 6, the time adjustment is performed by the time stamp information TMS. For example, when the time of [12:00:00] is input by the time stamp information TMS, the time of [12:00:00] is set as the internal time of the real-time clock device 20, as illustrated in A2. When the initial time adjustment is performed, the time correction valid flag is set to, for example, 1 as illustrated in A3, and the time correction is enabled.

As illustrated in A4, the input of the reference pulse signal PRF is started, and the time correction is executed as illustrated in A5, for example, at the initial input timing of the reference pulse signal PRF. The input timing, which is the edge timing of the reference pulse signal PRF, is set to the timing on the hour, and the time correction is executed at the input timing on the hour of the reference pulse signal PRF. For example, time correction for resetting the counter for less than a second of the clock count circuit 70 is executed. When the time correction is executed, the increment processing of the time interval count for every input timing of the reference pulse signal PRF is started as illustrated in A6, and the time correction flag is cleared (reset) to, for example, 0 as illustrated in A7.

The initial time adjustment is performed, the time correction is executed, and then the time comparison of the time less than a second is performed as illustrated in A8 at the input timing of the reference pulse signal PRF to detect the time lag. For example, it is determined whether or not the time lag occurs by detecting whether or not the last digit of 000 of less than a second (1 ms) changes from 0 to 1, for example. In A9, the sub-second lag, which is the time lag, is detected by comparing the time less than a second of the internal time. Specifically, as illustrated in A9, it is detected that the time lag of 1 ms occurs at the internal time at the input timing of the reference pulse signal PRF. That is, since the input timing of the reference pulse signal PRF is the timing on the hour, the time less than a second is required to be 000, but in A9, it is 001, and thus it is determined that the time lag, which is the sub-second lag, occurs. In the present embodiment, the accuracy of the time lag is described as 1 ms. For example, by providing a counter for milliseconds as the clock counter 72, an accuracy of 1 ms can be achieved. However, the accuracy of the time lag may be shorter than 1 ms or may be longer than 1 ms.

When it is determined that the time lag of the internal time occurs in this manner, the frequency correction of the oscillation clock signal CK is executed as illustrated in A10. Specifically, the frequency offset FOF=TE/TI=time lag amount/time interval is obtained, and the frequency correction of the oscillation clock signal CK is executed based on the obtained frequency offset FOF. For example, as illustrated in A9, the time lag amount TE is 1 ms. In addition, as illustrated in A11, the value of the time count is incremented from 0 to 1000, and thus the time interval TI of the time lag becomes 1000 s in 1000 counts×1 second. Therefore, as illustrated in A12, the frequency offset FOF=1 ms/1000 s=1 ppm is obtained, and the frequency correction of the oscillation clock signal CK is executed based on the frequency offset FOF. By executing the frequency correction, the time correction valid flag is set to 1 as illustrated in A13. As a result, as illustrated in A14, the time correction is executed at the timing when the reference pulse signal PRF is next input. Specifically, as illustrated in A15, the time less than a second of the internal time is reset to 000. For example, a counter on milliseconds is reset. When the time correction is executed In this manner, the time correction valid flag is cleared to 0 as illustrated in A16.

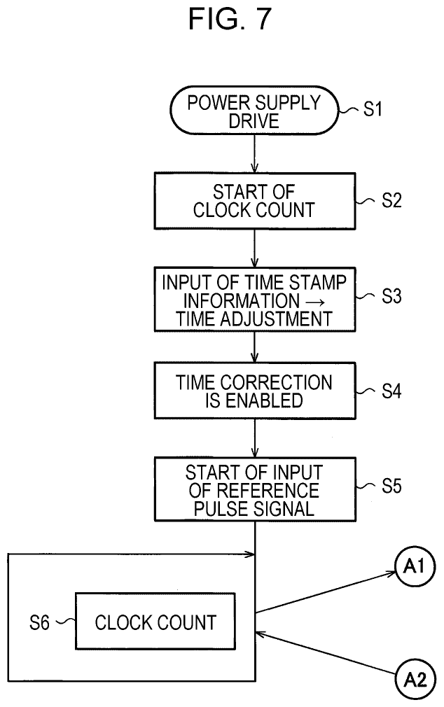

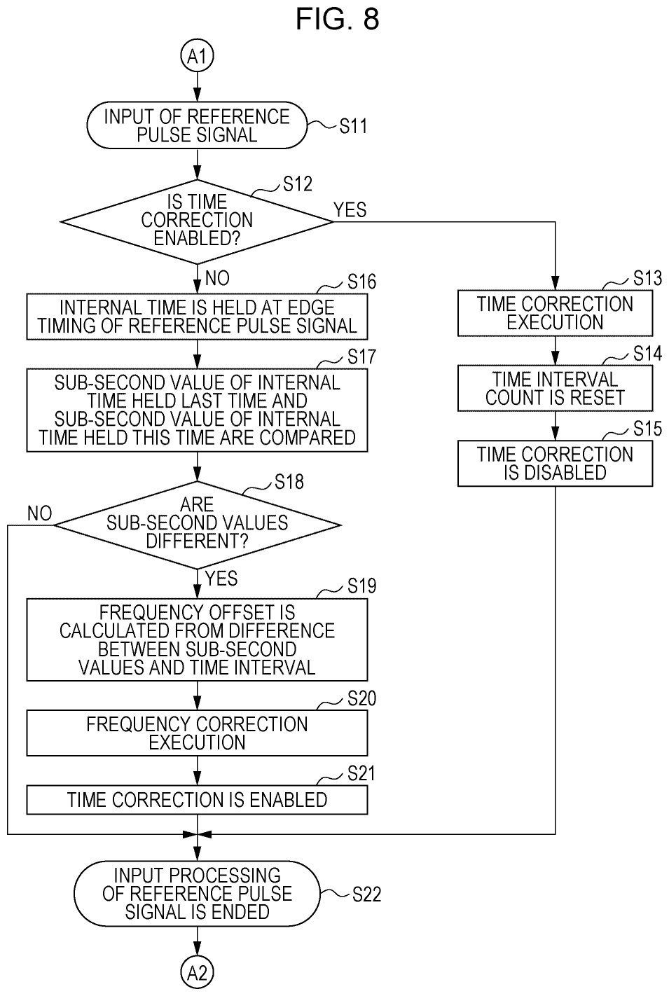

FIGS. 7 and 8 are flowcharts illustrating the operation of the real-time clock device 20 described in FIGS. 5 and 6. When the power is turned on and the real-time clock device 20 is activated, the clock count by the clock count circuit 70 is started (steps S1 and S2). In addition, as illustrated in A1 and A2 of FIG. 6, the initial time adjustment is performed using the time stamp information TMS, and as illustrated in A3, the time correction is enabled by setting the time correction valid flag (steps S3 and S4). As illustrated in A4 of FIG. 6, the input of the reference pulse signal PRF is started, and the clock count by the clock count circuit 70 is executed (steps S5 and S6).

As illustrated in FIG. 8, when the reference pulse signal PRF is input in the execution period of the clock count, it is determined whether or not the time correction is enabled (steps S11 and S12). That is, as illustrated in A3 of FIG. 6, it is determined whether or not the time correction valid flag is set. When the time correction is enabled, the time correction is executed as illustrated in A5 of FIG. 6 (step S13). When the time correction is executed, the time interval count is reset to 0 as illustrated in A6, the increment processing of the time interval count from 0 is started, and the time correction flag is cleared to 0 as illustrated in A7, so that the time correction is disabled (steps S14 and S15).

On the other hand, when the time correction flag is cleared to 0 and the time correction is disabled, the internal time is held at the edge timing of the reference pulse signal PRF (step S16). The sub-second value of the internal time held last time and the sub-second value of the internal time held this time are compared (step S17). When the sub-second value held last time and the sub-second value held this time are different from each other, and the sub-second lag, which is the time lag, is detected as illustrated in A9 of FIG. 6, the frequency offset FOF is calculated from the difference between the sub-second values, and the time interval (steps S18 and S19). That is, the frequency offset FOF is calculated based on the time lag amount TE, which is the difference between the sub-second values, and the time interval TI obtained based on the time interval count. Frequency correction is executed as illustrated in A10 based on the obtained frequency offset FOF (step S20). As illustrated in A13, the time correction valid flag is set, the time correction is enabled, and the input processing of the reference pulse signal PRF is ended (steps S21 and S22).

When the reference pulse signal PRF is next input, since the time correction is enabled, step S12 after step S11 of FIG. 8 is “YES”, and the time correction is executed as illustrated in A14 of FIG. 6 (step S13). The time interval count is reset, the time interval count from 0 is started, and the time correction is disabled by clearing the time correction valid flag as illustrated in A16 (steps S14 and S15).

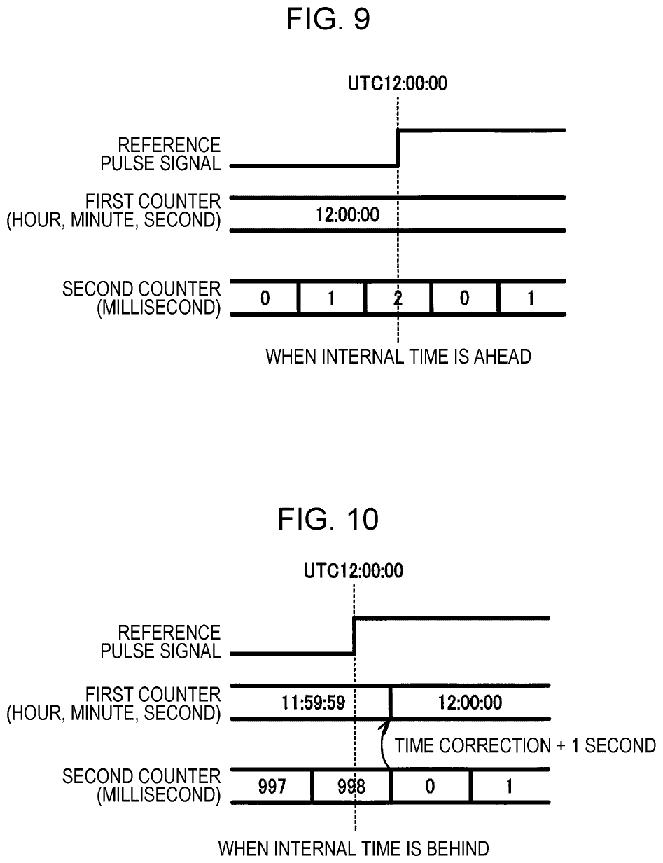

FIGS. 9 and 10 are explanatory diagrams of time correction control according to the present embodiment. For example, as illustrated in FIG. 5, the clock count circuit 70 is provided with a first counter 73 that counts an hour, a minute, and a second, and a second counter 74 that counts less than a second. For example, a counter that counts each of the hour, minute, and second is provided as the first counter 73, and a counter that counts milliseconds is provided as the second counter 74.

In FIG. 9, the internal time of the real-time clock device 20 is ahead of the hour of [12:00:00] indicated by the reference pulse signal PRF. That is, the first counter 73, that counts an hour, a minute, and a second, indicates [12:00:00], but since the second counter 74, which counts the milliseconds less than a second, for example, has a count value of 2, the internal time is ahead by, for example, 2 milliseconds. When it is determined that the internal time is ahead of the time corresponding to the reference pulse signal PRF in this manner, in the time correction, the count value of the second counter 74 is reset (cleared) to, for example, 0 as illustrated in FIG. 9.

On the other hand, in FIG. 10, the internal time of the real-time clock device 20 is behind the hour of [12:00:00] indicated by the reference pulse signal PRF. That is, the first counter 73, that counts an hour, a minute, and a second, indicates [11:59:59], and since the second counter 74, which counts the milliseconds less than a second, for example, has a count value of “998”, the internal time is behind by, for example, 2 milliseconds. When it is determined that the internal time is behind the time corresponding to the reference pulse signal PRF in this manner, in the time correction, the count value of the second counter 74 is reset to, for example, 0 as illustrated in FIG. 10, and a value corresponding to one second is added to the count value of the first counter 73. For example, the count value of the counter on seconds of the first counter 73 is incremented only by, for example, 1. In this manner, even when the internal time is ahead or behind at the timing when the reference pulse signal PRF is input, time correction for setting the count values of the first counter 73 and the second counter 74 to the count values corresponding to the hour can be executed. That is, when the internal time is ahead, as illustrated in FIG. 9, the count value of the second counter 74 that counts less than a second is reset, and the count value of the first counter 73 that counts an hour, a minute, and a second is left as it is, so that the count value can be set to the count value corresponding to the hour. In addition, when the internal time is behind, as illustrated in FIG. 10, the count value of the second counter 74 that counts less than a second is reset, and the count value of the first counter 73 that counts an hour, a minute, and a second is set to +1 second, so that the count value can be set to the count value corresponding to the hour.

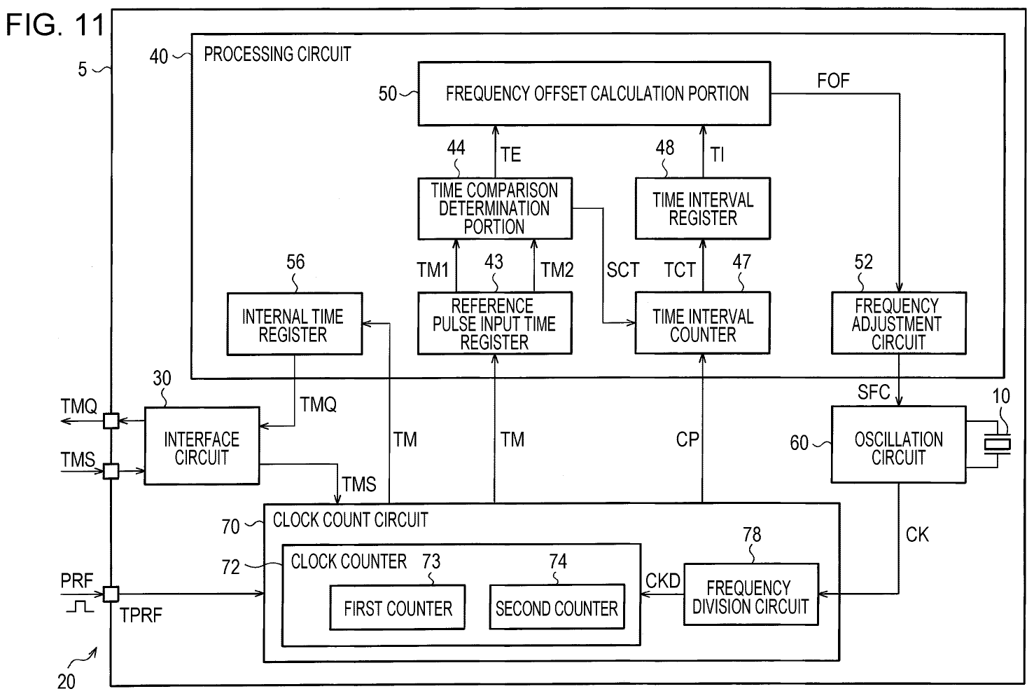

FIG. 11 is a diagram illustrating a detailed configuration example of the real-time clock device 20 according to the present embodiment. In FIG. 11, a reference pulse input time register 43 and a time comparison determination portion 44 are provided as the time lag calculation portion 42 of FIG. 5, and a time interval counter 47 and the time interval register 48 are provided as the time interval clocking portion 46 of FIG. 5.

The reference pulse input time register 43 holds the internal time TM at the timing at which the reference pulse signal PRF is input. For example, the reference pulse input time register 43 holds the internal time TM=TM1 at the first input timing of the reference pulse signal PRF and the internal time TM=TM2 at the second input timing of the reference pulse signal PRF. The time comparison determination portion 44 determines whether or not the time lag occurs by comparing the internal time TM1 at the first input timing with the internal time TM2 at the second input timing. When it is determined that the time lag occurs, the time comparison determination portion 44 outputs the time lag amount TE to the frequency offset calculation portion 50 and outputs a detection signal SCT of the time lag.

The time interval counter 47 performs the counting processing of the time interval count based on the count pulse CP activated for each input timing of the reference pulse signal PRF. For example, each time the count pulse CP is activated, the count value of the time interval count is incremented. When the time comparison determination portion 44 detects the time lag and outputs the detection signal SCT of the time lag, the count value TCT at that time is output from the time interval counter 47 and held in the time interval register 48. The time interval register 48 outputs the count value TCT as the time interval TI to the frequency offset calculation portion 50. The frequency offset calculation portion 50 calculates the frequency offset FOF based on the time lag amount TE from the time comparison determination portion 44 and the time interval TI from the time interval register 48, and the frequency adjustment circuit 52 outputs the frequency control signal SFC to the oscillation circuit 60 based on the frequency offset FOF. As a result, the frequency correction of the oscillation clock signal CK is executed.

### 3. Frequency Correction

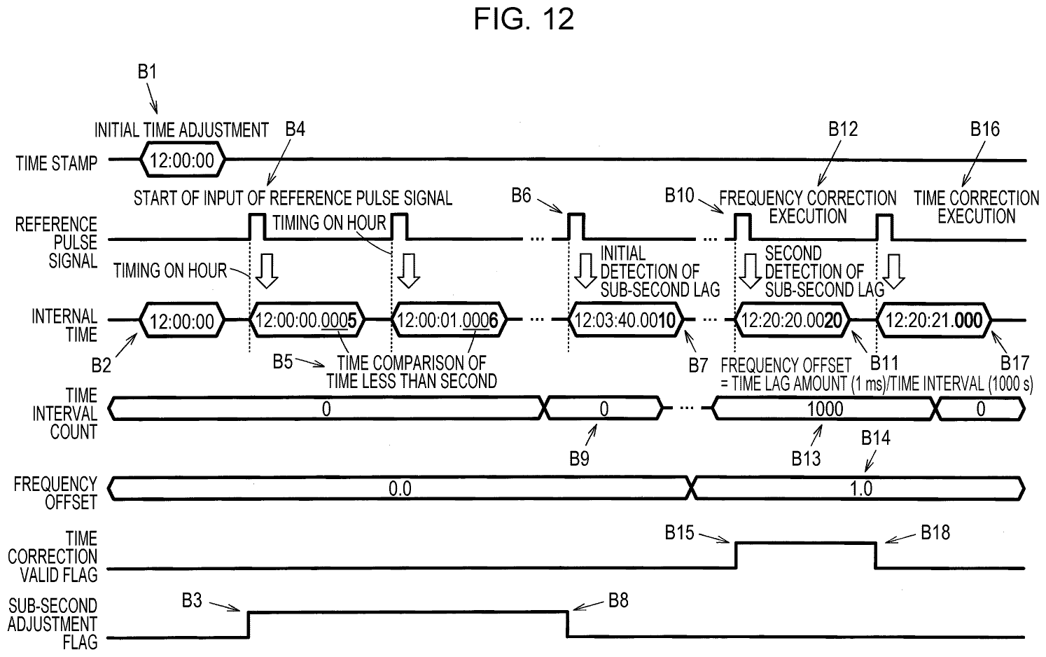

FIG. 12 is a signal waveform diagram illustrating the operation of the real-time clock device 20 of FIG. 11. As illustrated in B1 and B2 of FIG. 12, when the initial time adjustment is performed using the time stamp information TMS, a sub-second adjustment flag is set to, for example, 1 as illustrated in B3, and the input of the reference pulse signal PRF is started as illustrated in B4. That is, in FIG. 6, the time correction is performed at the initial input timing of the reference pulse signal PRF illustrated in A4. In B4 of FIG. 12, the time correction is not performed, and the sub-second adjustment flag, which is the time adjustment flag, is set to 1. As illustrated in B5, the sub-second lag, which is the time lag, is detected by performing the time comparison of the time less than a second of the internal time at the input timing of the reference pulse signal PRF. For example, it is determined whether or not the time lag occurs by comparing the internal time at the first input timing of the reference pulse signal PRF and the internal time at the next second input timing of the reference pulse signal PRF. For example, a comparison of the time less than a second of the internal time (000) is performed.

At the input timing of the reference pulse signal PRF illustrated in B6, the initial time lag (sub-second lag) of the internal time is detected as illustrated in B7. For example, the time less than a second of the internal time is 001, and a time lag of 1 millisecond is detected. When the initial time lag is detected in this manner, the sub-second adjustment flag is cleared to, for example, 0 as illustrated in B8, and the increment from 0 of the time interval count of the time lag is started as illustrated in B9.

Next, at the input timing of the reference pulse signal PRF illustrated in B10, the second time lag (sub-second lag) of the internal time is detected as illustrated in B11. For example, in B7, which is the initial time lag, the time less than a second of the internal time is 001, whereas in B11, which is the second time lag, the time less than a second of the internal time is 002, and thus a time lag of 1 millisecond corresponding to the minimum resolution of time accuracy is generated. In FIG. 12, when the second time lag occurs in this manner, the frequency correction is executed as illustrated in B12. For example, as illustrated in B7 and B11, the time lag amount TE is 1 ms. In addition, as illustrated in B13, the value of the time count is incremented from 0 to 1000, and thus the time interval TI of the time lag becomes 1000 s in 1000 counts×1 second. Therefore, as illustrated in B14, the frequency offset FOF=1 ms/1000 s=1 ppm is obtained, and the frequency correction of the oscillation clock signal CK is executed based on the frequency offset FOF. By executing the frequency correction, the time correction valid flag is set to 1 as illustrated in B15. As a result, as illustrated in B16, the time correction is executed at the timing when the reference pulse signal PRF is next input. Specifically, as illustrated in B17, the time less than a second of the internal time is reset to 000. For example, a counter on milliseconds is reset. When the time correction is executed In this manner, the time correction valid flag is cleared to 0 as illustrated in B18.

For example, when a synchronization signal or the like for time information on a network is used as the reference pulse signal PRF, the accuracy of the time indicated by the input timing of the reference pulse signal PRF may be lower than that of 1 PPS of the GPS. For example, in B5 of FIG. 12, a comparison of the time less than a second of the internal time is performed, but the digits less than 000 of less than a second at the input timing of the reference pulse signal PRF is not 0, but are, for example, 5 or 6, and the time accuracy is lowered. Therefore, as illustrated in FIG. 6, when the count of the time interval is performed from the first input timing of the reference pulse signal PRF, there is a possibility that an inaccurate time interval is measured.

In this regard, in FIG. 12, since the time interval TI of the time lag is measured based on the time interval count between the timing of the first time lag of B6 and B7 and the timing of the second time lag of B10 and B11, for example, the time interval TI in which the time lag of 1 millisecond occurs can be accurately measured. Therefore, since the frequency offset FOF can be obtained by using the accurate time interval TI, even when the time accuracy of the reference pulse signal PRF is low, a high-accuracy frequency correction can be realized.

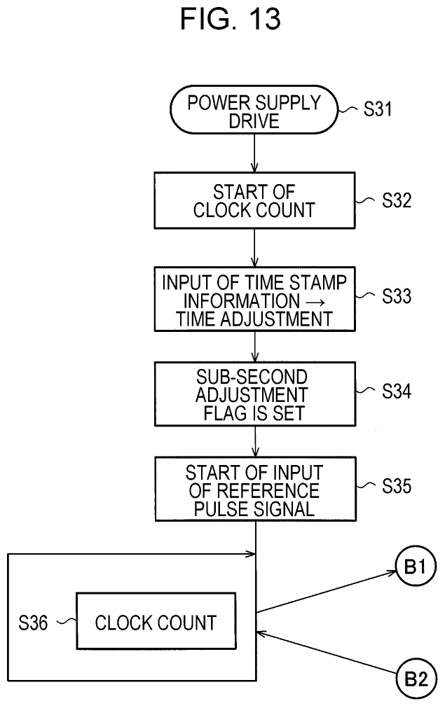

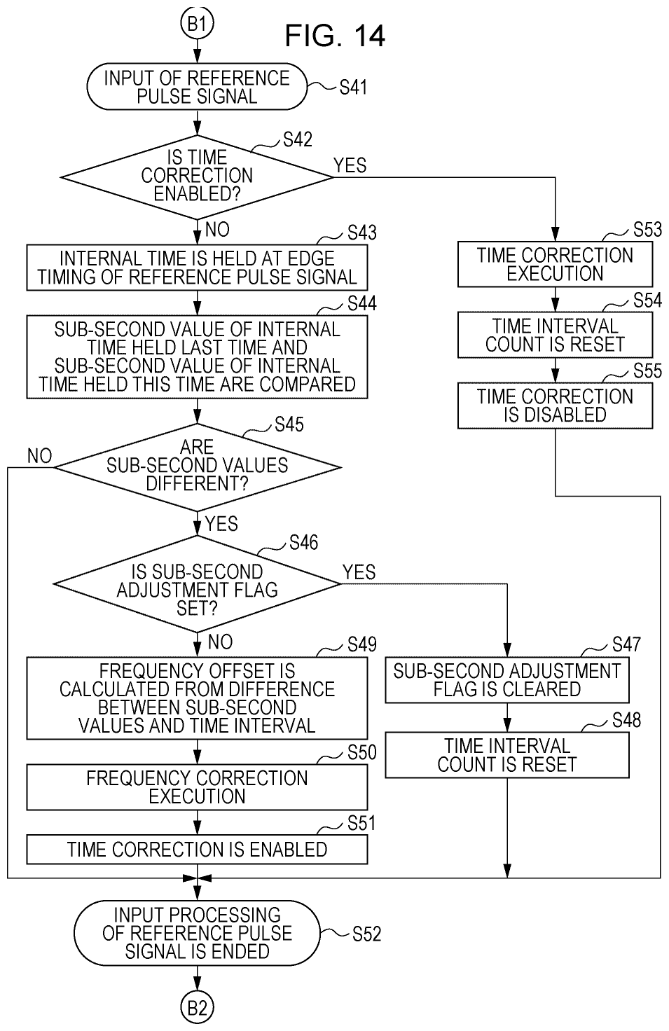

FIGS. 13 and 14 are flowcharts illustrating the operation of the real-time clock device 20 described in FIGS. 11 and 12. When the power is turned on and the real-time clock device 20 is activated, the clock count is started, the initial time adjustment is performed by the time stamp information TMS as illustrated in B1 and B2 of FIG. 12, and the sub-second adjustment flag is set to 1 as illustrated in B3 (steps S31, S32, S33, and S34). As illustrated in B4, the input of the reference pulse signal PRF is started, and the clock count by the clock count circuit 70 is executed (steps S35 and S36).

As illustrated in FIG. 14, when the reference pulse signal PRF is input in the execution period of the clock count, it is determined whether or not the time correction is enabled (steps S41 and S42). When the time correction flag is cleared to 0 and the time correction is disabled, the internal time is held at the edge timing of the reference pulse signal PRF (step S43). The sub-second value of the internal time held last time and the sub-second value of the internal time held this time are compared (step S44).

When the sub-second value held last time and the sub-second value held this time are different from each other, and the first sub-second lag is detected as illustrated in B7 of FIG. 12, it is determined whether or not the sub-second adjustment flag is set (steps S45 and S46). In the first sub-second lag, since the sub-second adjustment flag is set to 1, the sub-second adjustment flag is cleared to 0 as illustrated in B8 in FIG. 12, the time interval count is reset as illustrated in B9, and the time interval count is started (steps S47 and S48).

On the other hand, when the sub-second value held last time and the sub-second value held this time are different from each other and the second sub-second lag is detected as illustrated in B11 in FIG. 12, it is determined whether or not the sub-second adjustment flag is set (steps S45 and S46). In the second sub-second lag, since the sub-second adjustment flag is not set to 1, the frequency offset FOF is calculated from the difference between the sub-second values and the time interval (step S49). Frequency correction is executed as illustrated in B12 based on the obtained frequency offset FOF (step S50). As illustrated in B15, the time correction valid flag is set, the time correction is enabled, and the input processing of the reference pulse signal PRF is ended (steps S51 and S52).

When the reference pulse signal PRF is next input, since the time correction is enabled, step S42 after step S41 of FIG. 14 is “YES”, and the time correction is executed as illustrated in B16 of FIG. 12 (step S53). The time interval count is reset, the time interval count from 0 is started, and the time correction is disabled by clearing the time correction valid flag as illustrated in B18 (steps S54 and S55).

As described above, the real-time clock device 20 of the present embodiment includes the input terminal TPRF to which the reference pulse signal PRF of the time is input, the oscillation circuit 60 that outputs the oscillation clock signal CK, the clock count circuit 70 that generates the information on the internal time based on the oscillation clock signal CK, and the processing circuit 40, as illustrated in FIGS. 1, 5, and 11. When it is determined that the time lag occurs at the internal time in a case in which the reference pulse signal PRF is input, the processing circuit 40 performs frequency correction of the oscillation clock signal CK based on the time lag amount and the time interval of the time lag, and time correction of the internal time. For example, in FIG. 6, the processing circuit 40 executes the frequency correction of the oscillation clock signal CK as illustrated in A10, and executes the time correction as illustrated in A14, when it is determined that the time lag occurs as illustrated in A9. In addition, also in FIG. 12, the processing circuit 40 executes the frequency correction as illustrated in B12 and executes the time correction as illustrated in B16 when it is determined that the time lag occurs as illustrated in B11. The time correction may be performed after the frequency correction is performed, at the input timing of the next reference pulse signal PRF. The frequency correction of the oscillation clock signal CK is performed based on the time lag amount TE illustrated in A9 of FIGS. 6 and B11 and B7 of FIG. 12 and the time interval TI of the time lag measured by the time interval count in A6 and A11 of FIGS. 6 and B9 and B13 of FIG. 12, for example. For example, the frequency offset is obtained based on the time lag amount TE and the time interval TI of the time lag, and the oscillation frequency of the oscillation circuit 60 is adjusted based on the frequency offset, and thus the frequency correction of the oscillation clock signal CK is executed.

As described above, in the present embodiment, the reference pulse signal PRF is provided at the input terminal TPRF, and it is determined whether or not the time lag occurs at the internal time at the input timing of the reference pulse signal PRF input to the input terminal TPRF. When it is determined that the time lag occurs, the frequency correction of the oscillation clock signal CK and the time correction of the internal time are executed. As a result, the time correction for updating the internal time to the accurate time is performed, and the frequency correction for bringing the frequency error close to zero is performed. That is, the frequency offset inside the RTC is estimated and corrected based on the time information inside the RTC at the timing when the reference pulse signal PRF is input. As a result, the clock count error caused by the offset shift of the oscillation frequency due to the aging is prevented, and a highly accurate time can be provided. Therefore, the real-time clock device 20 that can provide accurate time information and maintain time accuracy can be provided. For example, by incorporating the correction function into the RTC module of one package, a highly accurate time can be provided with a small size and low power consumption.

In addition, the processing circuit 40 determines whether or not the time lag occurs by comparing, for example, the internal time at the first input timing of the reference pulse signal PRF and the internal time at the second input timing of the reference pulse signal PRF after the first input timing. For example, in B5 of FIG. 12, it is determined that the time lag occurs by comparing the time less than a second of the internal time at the first input timing and the internal time at the second input timing of the reference pulse signal PRF. The time comparison of the time less than a second is, for example, a time comparison of a predetermined digit of less than a second, and, for example, in B5, a time comparison of a digit of 1 millisecond corresponding to the minimum resolution is performed. The time comparison can be realized by comparing, for example, the count values of a counter of 1 millisecond. In B11 and B7, since the time lag of less than a second of the internal time is detected, it is determined that the time lag of the internal time occurs, and the frequency correction in B12 and the time correction in B16 are executed.

In this manner, by comparing the internal times of each of the input timings of the reference pulse signal PRF, the time lag of the internal time can be determined. Instead of comparing the internal time at the first input timing with the internal time at the second input timing of the reference pulse signal PRF, when a predetermined digit less than a second (for example, the digit of 1 millisecond) is changed as in A9 of FIG. 6, it may be determined that the time lag of the internal time occurs.

In addition, the processing circuit 40 performs time correction of the internal time at the timing when the reference pulse signal PRF is next input after the frequency correction is performed. For example, in FIG. 6, at the k-th input timing of the reference pulse signal PRF (k is an integer of 1 or more), it is determined that the time lag occurs as illustrated in A9, and the frequency correction of the oscillation clock signal CK is executed as illustrated in A10. At the next (k+1)-th input timing of the reference pulse signal PRF, the time correction of the internal time is executed as illustrated in A14. Similarly, in FIG. 12, at the k-th input timing of the reference pulse signal PRF, it is determined that the time lag occurs as illustrated in B11, and the frequency correction of the oscillation clock signal CK is executed as illustrated in B12. At the next (k+1)-th input timing of the reference pulse signal PRF, the time correction of the internal time is executed as illustrated in B16.

In this manner, accurate time correction can be realized as compared with a case where both the frequency correction and the time correction are executed in the period corresponding to the input timing of the reference pulse signal PRF. For example, at the k-th input timing of the reference pulse signal PRF, the time lag of the internal time is detected, and the calculation period is required until the execution of the frequency correction is completed. Therefore, when the time correction is executed after the calculation period elapses, there is a possibility that the accurate time correction cannot be performed. In this regard, after the frequency correction is performed, when the time correction of the internal time is performed at the timing when the reference pulse signal PRF is next input, the time correction can be performed in a short time at the (k+1)-th input timing of the reference pulse signal PRF, and the time correction can be further accurately performed.

In addition, the processing circuit 40 may not perform the frequency correction when it is determined that the time lag occurs for the first time, which is the initial time, and may perform the frequency correction when it is determined that the time lag occurs for the second time. For example, in FIG. 12, when the time lag occurs for the first time, which is the initial time, as illustrated in B6 and B7, the frequency correction is not executed, and when the time lag occurs for the second time as illustrated in B10 and B11, the frequency correction is executed as illustrated in B12.

In this manner, the time interval TI of the time lag can be accurately measured, and the frequency correction of the oscillation clock signal CK can be performed by using a more accurate time interval TI. For example, depending on the type of the reference pulse signal PRF, as illustrated in B5 of FIG. 12, the accuracy of less than a second at the input timing of the reference pulse signal PRF may be low, and for example, the digit lower than 000 may not be 0. Therefore, in such a case, when the time interval TI of the time lag is measured as illustrated in A6 and A11 of FIG. 6, there is a possibility that the accuracy of the time interval TI is low, and the accuracy of the frequency correction is also low. In this regard, in FIG. 12, when it is determined that the time lag occurs for the first time as illustrated in B6 and B7, the frequency correction is not performed, and when it is determined that the time lag occurs for the second time as illustrated in B10 and B11, the frequency correction is performed as illustrated in B12. Therefore, the time interval TI of the time lag used for the frequency correction can be accurately measured. For example, since the difference between the first time lag illustrated in B7 and the second time lag illustrated in B11 is exactly 1 millisecond, which is the minimum resolution of the time accuracy, the time interval at which the time lag of 1 millisecond occurs can be further accurately measured by the time interval count of B9 and B13. Therefore, since the frequency offset FOF=time lag amount/time interval=TE/TI can be obtained by using the accurate time interval TI, even when the time accuracy of the reference pulse signal PRF is low, a high-accuracy frequency correction can be realized.

In addition, the time interval TI of the time lag is, for example, the time interval from when the time correction is performed to when the time lag is detected next. For example, in FIG. 6, at the i-th input timing of the reference pulse signal PRF, the time correction is performed as illustrated in A5, and the counting of the time interval of the time lag is started as illustrated in A6. When it is determined that the time lag occurs at the j-th input timing of the reference pulse signal PRF as illustrated in A9 (i and j are integers such that j>i), the time interval TI of the time lag is obtained by the count value of the time interval illustrated in A11. As described above, the time interval TI of the time lag is a time interval from when the time correction is performed as illustrated in A5 to when the time lag is detected next as illustrated in A9. In this manner, a period from a state where the time lag does not occur to when the time lag occurs is regarded as the time interval of the time lag, and the frequency correction of the oscillation clock signal CK can be realized.

In addition, as illustrated in FIGS. 5 and 11, the clock count circuit 70 includes the first counter 73 that counts an hour, a minute, and a second, and the second counter 74 that counts less than a second. For example, the first counter 73 includes a counter that counts each of an hour, a minute, and a second, and the second counter 74 includes a counter that counts less than a second, such as a counter on milliseconds. As described in FIG. 9, when the internal time is ahead of the time corresponding to the reference pulse signal PRF, the processing circuit 40 resets the count value of the second counter 74 in the time correction. For example, the count value of the counter on milliseconds is reset. On the other hand, as described with reference to FIG. 10, when the internal time is behind the time corresponding to the reference pulse signal PRF, the processing circuit 40 adds a value corresponding to one second to the count value of the first counter 73 in the time correction, and resets the count value of the second counter 74. For example, the count value of the counter on seconds of the first counter 73 is incremented by, for example, 1, and the count value of the counter on milliseconds of the second counter 74 is reset. In this manner, even when the internal time is ahead or behind at the timing when the reference pulse signal PRF is input, time correction for setting the count values of the first counter 73 and the second counter 74 to the count values corresponding to the hour can be executed.

In addition, as illustrated in FIGS. 5 and 11, the real-time clock device 20 includes the interface circuit 30 to which the time stamp information TMS is input, and the processing circuit 40 sets the information on the internal time based on the time stamp information TMS. For example, in A1 and A2 of FIGS. 6 and B1 and B2 of FIG. 12, the initial time adjustment of the internal time of the real-time clock device 20 is performed based on the time stamp information TMS input from the outside via the interface circuit 30, for example. For example, the time indicated by the time stamp information TMS is set in the internal time register of the real-time clock device 20, so that such time adjustment is realized.

In this manner, the time adjustment such as the initial time adjustment of the real-time clock device 20 can be performed by using the time stamp information TMS input from the outside. After such a time adjustment using the time stamp information TMS, the time lag of the internal time is detected by using the reference pulse signal PRF input via the input terminal TPRF, and the time correction of the internal time and the frequency correction of the oscillation clock signal CK can be performed. For example, after the time adjustment is performed for the initial time using the time stamp information TMS, the internal time of the real-time clock device 20 can be maintained at an accurate time by using only the input reference pulse signal PRF.

For example, the processing circuit 40 performs the frequency correction and the time correction when it is determined that the time lag occurs after the information on the internal time is set based on the time stamp information TMS. For example, in FIG. 6, when the time adjustment is performed by setting the information on the internal time based on the time stamp information TMS in A1 and A2, and it is determined that the time lag occurs in A9, the frequency correction and the time correction are executed as illustrated in A10 and A14. In FIG. 12, when the time adjustment is performed by setting the information on the internal time based on the time stamp information TMS in B1 and B2, and it is determined that the time lag occurs in B11 and B7, the frequency correction and the time correction are executed as illustrated in B12 and B16.

In this manner, after the internal time is set by the time stamp information TMS, the detection of the time lag, the frequency correction of the oscillation clock signal CK, and the time correction of the internal correction are performed by the input reference pulse signal PRF. Therefore, the internal time set by the time stamp information TMS can be maintained at an accurate time.

Various modifications can be made in the present embodiment. For example, only the frequency correction may be performed without performing the automatic time correction, and the time correction may be performed by writing the time information appropriately by the user separately from the reference pulse signal. In addition, for example, the update (correction) of the internal time may be performed by detecting the communication end timing of serial communication such as SPI and I2C performed by the interface circuit. For example, in the case of SPI, the detection timing of the falling of the CE signal (chip enable signal) can be used, and in the case of I2C, the detection timing of the STOP condition or the repeated START condition can be used. As a result, when it is not necessary to accurately adjust the time, the time can be updated even without using the 1 PPS signal.

As described above, the real-time clock device of the present embodiment includes the input terminal to which the reference pulse signal of the time is input, the oscillation circuit that outputs the oscillation clock signal, and the clock count circuit that generates the information on the internal time based on the oscillation clock signal. In addition, the real-time clock device includes the processing circuit that performs, in a case in which it is determined that a time lag occurs at the internal time when the reference pulse signal is input, the frequency correction of the oscillation clock signal based on the time lag amount and the time interval of the time lag, and the time correction of the internal time.

According to the present embodiment, it is determined whether or not the time lag occurs at the internal time at the input timing of the reference pulse signal input to the input terminal, and when it is determined that the time lag occurs, the frequency correction of the oscillation clock signal and the time correction of the internal time are executed. As a result, the time correction for updating the internal time to the accurate time is performed, and the frequency correction for bringing the frequency error close to zero is performed. Therefore, the real-time clock device that can provide accurate time information and maintain time accuracy can be provided.

In addition, in the present embodiment, the processing circuit may determine whether or not the time lag occurs by comparing the internal time at the first input timing of the reference pulse signal with the internal time at the second input timing of the reference pulse signal after the first input timing.

In this manner, by comparing the internal times of each of the input timings of the reference pulse signal, the time lag of the internal time can be determined.

In addition, in the present embodiment, the processing circuit may perform the time correction of the internal time at the timing when the reference pulse signal is next input after the frequency correction is performed.

In this manner, accurate time correction can be realized as compared with a case where both the frequency correction and the time correction are executed in the period corresponding to the input timing of the reference pulse signal.

In addition, in the present embodiment, the processing circuit may not perform the frequency correction when it is determined that the time lag occurs for the first time, which is the initial time, and may perform the frequency correction when it is determined that the time lag occurs for the second time.

In this manner, the time interval of the time lag can be accurately measured, and the frequency correction of the oscillation clock signal can be performed by using a more accurate time interval.

In addition, in the present embodiment, the time interval of the time lag may be the time interval from when the time correction is performed to when the time lag is detected next.

In this manner, the period from the state where the time lag does not occur to when the time lag occurs is regarded as the time interval of the time lag, and the frequency correction of the oscillation clock signal can be realized.

In addition, in the present embodiment, the clock count circuit may include the first counter that counts an hour, a minute, and a second, and a second counter that counts less than a second. The processing circuit may reset the count value of the second counter in the time correction, when the internal time is ahead of the time corresponding to the reference pulse signal. In addition, the processing circuit may add the value corresponding to one second to the count value of the first counter in the time correction when the internal time is behind the time corresponding to the reference pulse signal to reset the count value of the second counter.

In this manner, even when the internal time is ahead or behind at the timing when the reference pulse signal is input, the time correction for setting the count values of the first counter and the second counter to the count values corresponding to the hour can be executed.

In addition, in the present embodiment, the processing circuit may include the interface circuit to which the time stamp information is input, and the processing circuit may set the information on the internal time based on the time stamp information.

In this manner, the time adjustment of the real-time clock device can be performed by using the time stamp information input from the outside.

In addition, in the present embodiment, the processing circuit may perform the frequency correction and the time correction when it is determined that the time lag occurs after the information on the internal time is set based on the time stamp information.

In this manner, the internal time set by the time stamp information can be maintained at an accurate time.

Although the present embodiment is described in detail as described above, it will be easily understood by those skilled in the art that various modifications could be made without substantially departing from the novel matters and effects of the present disclosure. Therefore, all such modification examples fall within the scope of the present disclosure. For example, a term described at least once together with a different term having a broader meaning or the same meaning in the specification or the drawings can be replaced with a different term anywhere in the specification or the drawings. In addition, all combinations of the present embodiment and modification examples also fall within the scope of the present disclosure. In addition, the configuration, operation, and the like of the real-time clock device are not limited to those described in the present embodiment, and various modifications can be made.

What is claimed is:

1. A real-time clock device comprising:
an input terminal to which a reference pulse signal of a time is input;
an oscillation circuit that outputs an oscillation clock signal;
a clock count circuit that generates information on an internal time based on the oscillation clock signal; and
a processing circuit that performs, in a case in which it is determined that a time lag occurs at the internal time when the reference pulse signal is input, frequency correction of the oscillation clock signal based on a time lag amount and a time interval of the time lag, and time correction of the internal time.

2. The real-time clock device according to claim 1, wherein
the processing circuit determines whether or not the time lag occurs by comparing the internal time at a first input timing of the reference pulse signal with the internal time at a second input timing of the reference pulse signal after the first input timing.

3. The real-time clock device according to claim 1, wherein
the processing circuit performs the time correction of the internal time at a timing when the reference pulse signal is next input after the frequency correction is performed.

4. The real-time clock device according to claim 1, wherein
the processing circuit does not perform the frequency correction when it is determined that the time lag occurs for a first time, which is an initial time, and performs the frequency correction when it is determined that the time lag occurs for a second time.

5. The real-time clock device according to claim 1, wherein
the time interval of the time lag is a time interval from when the time correction is performed to when the time lag is detected next.

6. The real-time clock device according to claim 1, wherein
the clock count circuit includes
a first counter that counts an hour, a minute, and a second, and
a second counter that counts less than a second, and
the processing circuit resets a count value of the second counter in the time correction when the internal time is ahead of a time corresponding to the reference pulse signal, and
adds a value corresponding to one second to a count value of the first counter in the time correction when the internal time is behind the time corresponding to the reference pulse signal to reset the count value of the second counter.

7. The real-time clock device according to claim 1, further comprising:
an interface circuit to which time stamp information is input, wherein
the processing circuit sets the information on the internal time based on the time stamp information.

8. The real-time clock device according to claim 7, wherein
the processing circuit performs the frequency correction and the time correction when it is determined that the time lag occurs after the information on the internal time is set based on the time stamp information.
